(19) United States
(12) Patent Application Publication
(10) Pub. No.: US 2006/0184791 A1
(43) Pub. Date: Aug. 17, 2006

(54) Encryption/decryption mechanism of network deployed executable image for secure boot of a device embedded in an un-trusted host

(76) Inventors: Mariano R. Schain, Ramat-Hasharon (IL); Barak Hermesh, Menashe (IL); Zvika Shaubi, Tel-Aviv (IL)

Correspondence Address: TEXAS INSTRUMENTS INCORPORATED, P O BOX 655474, M/S 3999, DALLAS, TX, 75265, US

(21) Appl. No.: 11/057,778

(22) Filed: Feb. 14, 2005

(51) Int. Cl. H04L 9/00

(52) U.S. Cl. 713/164

(57) ABSTRACT

A method for secure remote storage of system-boot executable image for a network access device embedded in an untrusted remote user device operably connected to a service provider's network. In an exemplary embodiment, a copy of service provider's executable image is distributed to provider's network access device by the central network administration system. The executable image is encrypted locally by the provider's network access device using a unique encryption key which is generated by and stored in a non-volatile memory on said access device. The encrypted image is then passed to and stored in the non-volatile memory of the host user device. During system boot, the encrypted image is fetched from the host device to the network access device where it is decrypted and stored in active memory of the network device during normal system operations. This results in cost savings to provider by limiting remote access device's non-volatile storage requirements.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to the field of security of network operations. More specifically, the present invention is a method of local encryption and decryption of a bootable network image for storage on a remote untrusted host user device.

### BACKGROUND OF THE INVENTION

Network-delivered services providers sometimes employ user-end network access devices (e.g., a cable modem) which are embedded within a user's host receiving device (e.g., a set-top-box) at the network-to-user interface point. In this situation, an executable image of the provider's software, which is activated during the system boot process may be stored for system access at this remote interface point. This would tend to be typical for each and every user of the system, regardless of the specific model of receiving device.

In the above scenario, the original software image and any user-specific updates are delivered to the interface point by a dedicated software update mechanism maintained by the provider. As devices are reduced in size, it will be increasingly uncommon for provider access devices to possess sufficient persistent storage (e.g., non-volatile memory) to retain the software image. In such situations, it is preferable for the image to be permanently stored on the host device. During the system boot process, the network access device fetches the image from the host device. The fetched image is then stored in the active memory of the access device for use during normal operations.

Because host devices are not always secure, the image and its updates must be encrypted before storage on the host device. To avoid the potential for system-wide compromise, unique encryption keys should be developed for each interface point on the network.

Uniquely encrypting each device's code places a large burden on the network. The acts of encryption key generation, encryption, encrypted code and key dissemination, authorization and authentication processes, all utilize system resources. In addition, central management of the encryption administration creates a potential for losses. The network provider may suffer damages during security breaches in terms of opportunity costs (system-wide downtime) as well as legal liabilities.

### SUMMARY OF THE INVENTION

Addressing the above situation, the present invention comprises a method for local encryption/decryption and storage of a network-deployed executable image used for the secure boot of an access device embedded in an untrusted host user device.

In a first exemplary embodiment, a network provider's access device (e.g., a cable modem) is embedded in an untrusted host user device (e.g., a set-top-box). An executable image of the network provider's remote device boot and operating software is distributed to the user devices via a software distribution/update mechanism. The access device (as opposed to the network administrator) randomly generates a unique encryption key. The key is stored by the access device at the remote location. As executable code is received from the network, it is encrypted and stored on the host user device. During user system boot up, the encrypted code is recalled from the host device. The code is decrypted by the provider's access device and is stored in its active memory for use during the remainder of the boot process and regular network service operations.

In the event of an update to the code, the device-specific update is distributed to the remote interface point, encrypted by the access device using a newly generated key and stored on the host device as an update to the previous code.

This system of encryption on-the-fly conserves network system resources. Code may be developed for a single type of user device and distributed, as-is, without modification from its basic format to all such devices on the network without fear of system compromise by illicit operations at the host device. Thus there is no requirement for centralized encryption, distribution, storage or maintenance of the encrypted code by the network administrator on a user-specific basis.

Further, security of the network is enhanced by the invention. The randomly generated user-specific key prevents system-wide security breaches since identical keys are not created for same-type devices. An adversary may not use a compromised key to attack other similar devices. Nor are the keys stored centrally by the network. This prevents access to individualized user key information in the event of a central system breach.

### BRIEF DESCRIPTION OF THE DRAWINGS

Exemplary embodiments of the invention are discussed hereinafter in reference to the following drawings, in which:

FIG. 1 is a schematic representation of a series of user devices operatively connected to a series of network access devices employed remotely on a service provider's network. The network access devices are embedded within the “host” user devices.

FIG. 2 is a schematic representation of the minimum system requirements of any user device and any access device used in the combinations shown in FIG. 1.

FIG. 3 is a flowchart depicting the operations involved in the distribution and remote encryption and storage of the service provider's executable code.

FIG. 4 is a flowchart depicting the operations involved in the retrieval and decryption of the encrypted code during the remote system boot process.

### DETAILED DESCRIPTION OF PREFERRED EXEMPLARY EMBODIMENTS

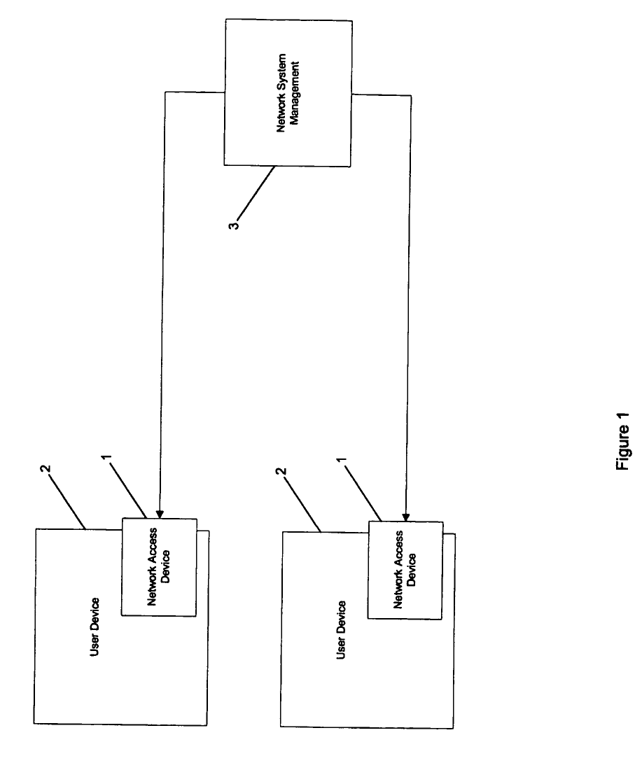

An inventive method is disclosed for remote encryption, decryption and secure storage of a network-deployed executable image used for the secure local boot and operation of an access device which is embedded in a host user device. As is illustrated in FIG. 1, one embodiment of the present invention comprises a series of network service provider's network access devices 1 embedded within a series of remote user devices 2. The access devices 1 are each operably connected to a central network services management system 3. The network provider's access device 1 is embedded within the user-controlled host user device 2 in such a manner as to permit network services to be made available to the host device. The user devices 2 are not necessarily all identical in form or function and in fact, may vary widely in these regards. The access devices 1 are each designed or adapted for the specific user device 2 into which they are embedded. This portion of the exemplary embodiment is similar to many typical network service provider systems.

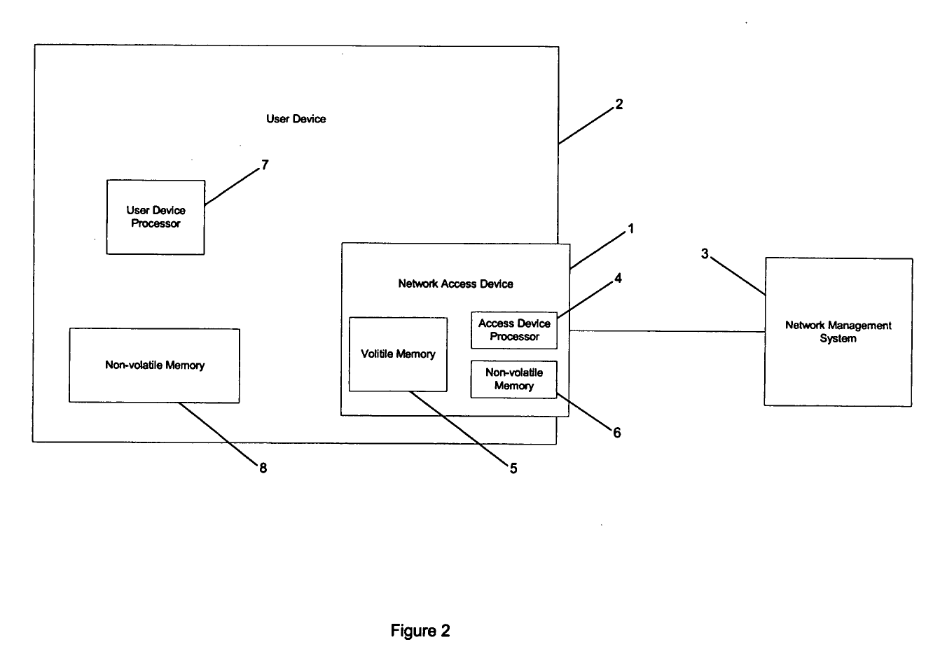

FIG. 2 depicts any of access devices 1 as generally comprising the minimum features of an access device processor 4, an active device volatile memory unit 5 and an access device non-volatile memory unit 6. Also shown is any user device 2 with the minimum features of a user device processor 7 and a user device non-volatile memory unit 8.

A network-provided remote device boot and operating program, also known as a “code” is developed for each combination of access device 1 and user device 2. This code is developed by the network service provider and is identical for each type of device combination on the network.

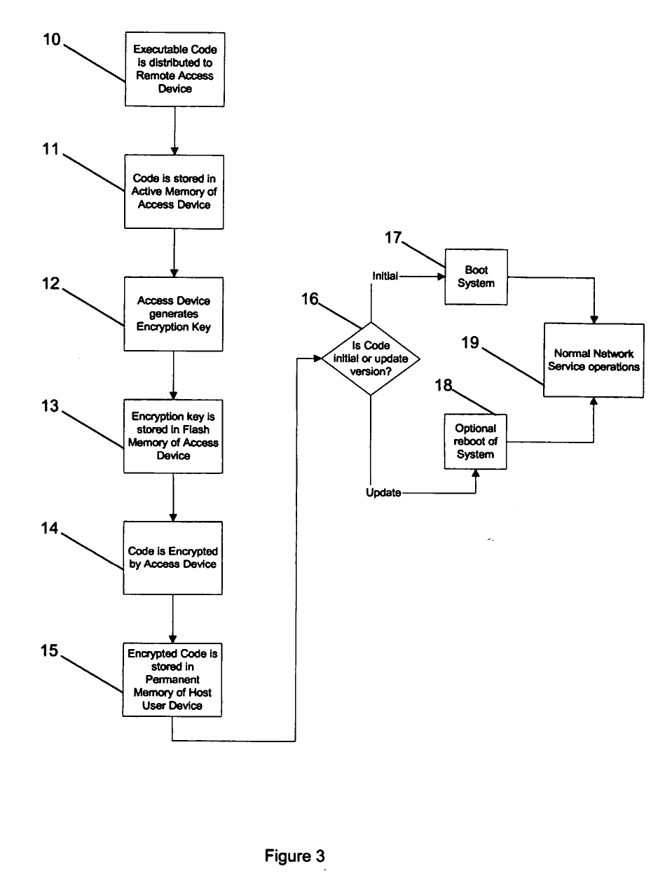

After remote system installation, an executable copy of the relevant code is distributed to an access device 1 by the network management system 3. This distribution is indicated in FIG. 3 in Box 10. Without prejudice to the invention, the distribution in Box 10 may be either an initial distribution of the code or it may be an update to the code, whichever is appropriate to the current service situation.

Upon receipt, the code is stored in the access device active (volatile) memory unit 5 as shown in Box 11. Next, the access device processor 4 generates an encryption key as indicated in Box 12. This key may be user-specific, sequential, random or of any other nature suitable to the network provider's requirements for security of the system. The key is stored in the access device non-volatile memory unit 6 as shown in Box 13.

Next, the executable code, which at this point resides in the temporary access device memory 5, is encrypted as indicated in Box 14 by access processor 4 using the key generated in Box 12. The encrypted code is passed from access device 1 to user device 2 and stored in the non-volatile storage unit 8 of user device 2. This is depicted in Box 15. Depending on the configuration of the access and host devices (1 and 2) processing of the encrypted code from the access device 1 to host device 2 may or may not involve user device processor 7. Either method is within the inventive scope of the invention as taught herein. The remotely encrypted code is now securely stored in persistent memory 8 of host user device 2.

Next, the code is checked to see if it is an initial or update version as shown in Box 16. If it is the system initiation version, the system is booted for normal operations as shown in Box 17. If the received code is an update, the system is optionally re-booted as shown in Box 18. In either case, subsequent to either booting, re-booting or not re-booting, the system is now functional and services are being provided as shown in Box 19.

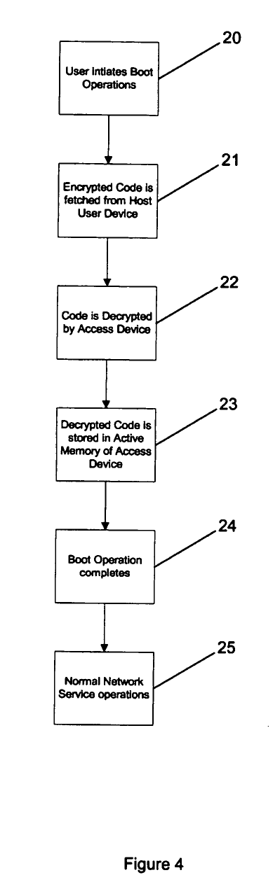

FIG. 4 depicts the user-initiated boot process which retrieves the encrypted code from the host device and activates the remote system. A user (or user-controlled system) initiates the boot operations of the remote network interface system as indicated in Box 20. This process may be accomplished by turning on user device 2, or it may be accomplished by any other means of boot initiation known to those skilled in the art without departing from the inventive method herein described.

As detailed in Box 21, the encrypted code is fetched from memory 8 of host device 2. Again, the interplay between devices is not significant so long as the processor 4 of access device 1 receives the encrypted code. Using the key stored in non-volatile access memory 6, the encrypted code is decrypted as shown in Box 22 and stored in active memory 5 of access device 1. Boot operations proceed as indicated in Box 24 and normal network service operations begin as in Box 25.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

1. A method for secure storage and boot of an executable image for a network access device on a remote user device operably connected to a network comprising the steps of:
conveying said executable image to said network access device;
localized encryption of said executable image;
transferring said encrypted image from said network access device to said user device;
storing of said encrypted image within non-volatile memory of said user device;
retrieval of said encrypted image from said user device by said network access device during remote system boot;
localized decryption of said retrieved encrypted executable image; and
loading said decrypted executable image on said network access device.

2. The method of claim 1, wherein said executable image comprises a network-provided, remote device boot and operating program for the operation of said network access device on the network.

3. The method of claim 2, wherein said network-provided, remote device boot and operating program may comprise initial or updated versions thereof.

4. The method of claim 1, wherein said remote user device comprises:
an operational unit designed to interface with said network, having:
a user device processor and non-volatile memory unit contained within said operational unit; and
additional functional units as required for the operation of said device in conjunction with said access device, said network and said executable image.

5. The method of claim 1, wherein said network access device comprises:
an operational unit designed to interface with said remote user device, having:
an access device processor and volatile memory contained within said operational unit;
additional functional units as required for the operation of said device in conjunction with said remote user device, said network and said executable image.

6. The method of claim 1, wherein said localized encryption comprises the steps of:
generation of a local encryption key by said network access device;
storage of said encryption key in said non-volatile memory of said network access device; and
encrypting by said access device of said executable image into an encrypted image utilizing said locally generated encryption key.

7. The method of claim 6, wherein said encryption key may be generated randomly, sequentially or in any other manner suited to the level of protection desired for said network.

8. The method of claim 6, wherein said localized decryption comprises decryption of said encrypted image by said access device utilizing said locally generated encryption key.

9. A system for secure storage and boot of an executable image for a network access device on a remote user device operably connected to a network comprising:
a network access device embedded in said remote user device connected to a network server for communication of said executable image to said network access device and having a local encryption algorithm for encryption of said executable image and connected to said remote user device for bi-directional transfer of said encrypted executable image from said network access device to said remote user device;
non-volatile storage within said user device; and
a local decryption algorithm for execution by said network access device for retrieval of said encrypted executable image during remote system boot.

10. The system of claim 9, wherein said executable image comprises a network-provided, remote device boot and operating program for the operation of said network access device on the network.

11. The system of claim 10, wherein said network-provided, remote device boot and operating program may comprise initial or updated versions thereof.

12. The system of claim 9, wherein said remote user device comprises:
an operational unit designed to interface with said network, having a user device processor and non-volatile memory unit.

13. The system of claim 9, wherein said network access device comprises:
an operational unit designed to interface with said remote user device, having an access device processor and volatile and non-volatile memory units.

14. The system of claim 9, wherein said localized encryption algorithm comprises:
generation of an encryption key by said network access device;
storage of said encryption key in said non-volatile memory of said network access device;
encrypting of said executable image into an encrypted image utilizing said locally generated encryption key.

15. The system of claim 14, wherein said encryption key may be generated randomly, sequentially or in any other manner suited to the level of protection desired for said network.

16. The system of claim 14 wherein said localized decryption algorithm comprises decryption of said encrypted image by said access device back into said executable image utilizing said locally generated encryption key.

17. The method of claim 4 wherein said user device processor may be one of any variety of CPU.

18. The method of claim 4 wherein said access device processor may be one of any variety of CPU.

19. The system of claim 12 wherein said user device processor may be one of any variety of CPU.

20. The system of claim 13 wherein said access device processor may be one of any variety of CPU.
